(19) United States
(12) Patent Application Publication
(10) Pub. No.: US 2020/0225560 A1
(43) Pub. Date: Jul. 16, 2020

(54) MANUAL FOCUS ASSIST

(71) Applicant: SZ DJI TECHNOLOGY CO., LTD., Shenzhen (CN)

(72) Inventor: Xiaodan WANG, Shenzhen (CN)

(21) Appl. No.: 16/835,779

(22) Filed: Mar. 31, 2020

Related U.S. Application Data
(63) Continuation of application No. PCT/CN2017/115464, filed on Dec. 11, 2017.

(51) Int. Cl. G03B 13/16; G02B 7/36; H04N 5/232; G06T 7/80

(52) U.S. Cl. CPC G03B 13/16; G02B 7/36; H04N 5/23222; G06T 7/80; H04N 5/232945

(57) ABSTRACT

A manual focusing assist method includes analyzing an image captured by a photographing apparatus and containing an object to obtain a focusing evaluation function associated with the object, calculating a peak value for the object according to the focusing evaluation function, obtaining a current focusing value, and providing a focusing prompt based on the peak value and the current focusing value.

### CROSS-REFERENCE TO RELATED APPLICATION

This application is a continuation of International Application No. PCT/CN2017/115464, filed Dec. 11, 2017, the entire content of which is incorporated herein by reference.

### TECHNICAL FIELD

The present disclosure relates to photographing technique and, more particularly, to a method for assisting manual focus.

### BACKGROUND

As a conventional focus method, manual focus is still widely used on many photographing devices. Many auto focus photographing devices also have a manual focus mode as a supplement to the auto focus mode. The manual focus mode can be useful, for example, when the auto focus mode fails or does not work properly, e.g., in a low illumination environment.

In a manual focus mode, a user turns a focusing ring on a lens of the photographing device or presses a direction key on the photographing device to change the focus of the lens. Often times, an image is displayed on a screen of the photographing device, and the user determines whether the photographing device correctly focuses on a desired object by checking whether the image of the object on the screen appears in focus. This requires a lot of experience from the user. Further, the difficulty in making the determination increases, e.g., when the size of the screen is small or when the environment is bright.

### SUMMARY

In accordance with the present disclosure, there is provided a manual focusing assist method including analyzing an image captured by a photographing apparatus and containing an object to obtain a focusing evaluation function associated with the object, calculating a peak value for the object according to the focusing evaluation function, obtaining a current focusing value, and providing a focusing prompt based on the peak value and the current focusing value.

Also in accordance with the present disclosure, there is provided a manual focusing assist device including a processor and a memory storing instructions that, when executed by the processor, cause the processor to analyze an image captured by a photographing apparatus and containing an object to obtain a focusing evaluation function associated with the object, calculate a peak value for the object according to the focusing evaluation function, obtain a current focusing value, and provide a focusing prompt based on the peak value and the current focusing value.

Also in accordance with the present disclosure, there is provided a non-transitory computer-readable storage medium storing instructions that, when executed by a processor, cause the processor to analyze an image captured by a photographing apparatus and containing an object to obtain a focusing evaluation function associated with the object, calculate a peak value for the object according to the focusing evaluation function, obtain a current focusing value, and provide a focusing prompt based on the peak value and the current focusing value.

### BRIEF DESCRIPTION OF THE DRAWINGS

FIG. 1A is a schematic block diagram showing a photographing apparatus according to an exemplary embodiment.

FIG. 1B is a schematic block diagram showing the photographing apparatus and a remote controller of the photographing apparatus according to an exemplary embodiment.

FIG. 2 is a flow chart showing a manual focus assist method according to an exemplary embodiment.

FIG. 3 schematically shows a field of view of the photographing apparatus according to an exemplary embodiment.

FIGS. 4A-4C schematically show a focusing prompt according to an exemplary embodiment.

FIGS. 5A-5C schematically show a focusing prompt according to another exemplary embodiment.

FIGS. 6A-6C schematically show a focusing prompt according to another exemplary embodiment.

FIGS. 7A-7C schematically show a focusing prompt according to another exemplary embodiment.

FIGS. 8A-8C schematically show a focusing prompt according to another exemplary embodiment.

FIGS. 9A-9C schematically show a focusing prompt according to another exemplary embodiment.

### DESCRIPTION OF THE EMBODIMENTS

Hereinafter, embodiments consistent with the disclosure will be described with reference to the drawings, which are merely examples for illustrative purposes and are not intended to limit the scope of the disclosure. Wherever possible, the same reference numbers will be used throughout the drawings and the specification to refer to the same or like parts.

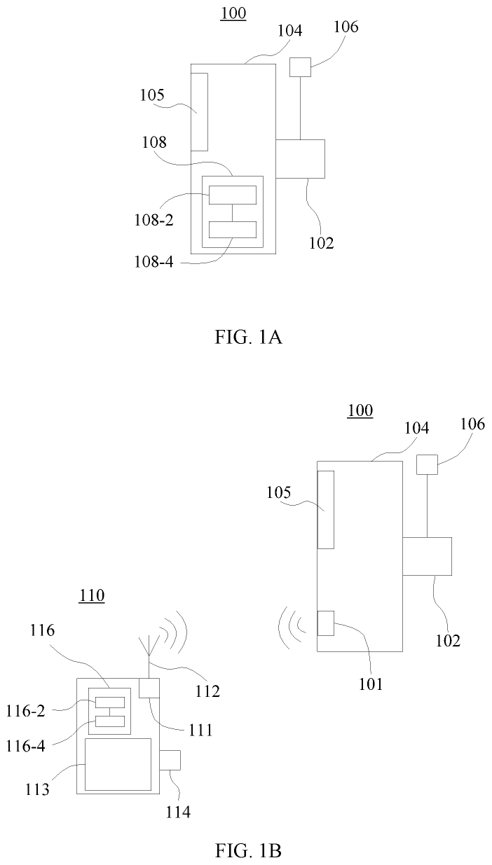

FIG. 1A schematically shows a photographing apparatus 100 consistent with the disclosure. The photographing apparatus 100 can be, for example, a camera, a camcorder, or any device having a photographing function, such as a smart phone. As used in this disclosure, the term “photographing function” refers to a function of taking images, such as still pictures and/or moving pictures. Further, the photographing apparatus 100 can be a manually operated photographing apparatus without any automatic functions, or can be an automatic photographing apparatus having both an auto focus (AF) mode a manual focus (MF) mode. AF techniques can be used to, for example, determine how optic components, e.g., a lens, of the photographing apparatus 100 can be adjusted. Such a determination can be performed without human intervention. In some situations, the adjustment can also be realized using AF techniques. For example, the lens can be turned by an AF motor to change focus according to the determination results. MF techniques can be an important supplement to the AF techniques, for example, when the motor cannot be controlled with a desired precision under the AF mode such as when the ambient illumination is too low. MF can be more precise than AF but the user may need some guidance to determine whether a captured image is in-focus, such as the guidance described in this disclosure. The captured image can be, for example, a preview image or a stored image.

The photographing apparatus 100 can be a hand-held photographing apparatus or can be remotely controlled using a remote controller, e.g., a dedicated remote controller or a smart device having a control application installed thereon for controlling the photographing apparatus 100. For example, the photographing apparatus 100 can be carried by an unmanned aerial vehicle (UAV) and controlled using the remote controller. FIG. 1B shows a remote controller 110 configured to control the photographing apparatus 100. The remote controller 110 can communicate with the photographing apparatus 100 through a wired or wireless connection. As shown in FIG. 1B, the photographing apparatus 100 includes a communication circuit 101 and the remote controller 110 includes a communication circuit 111. The communication circuit 101 and the communication circuit 111 are configured to communicate with each other to, for example, communicate control signals from the remote controller 110 to the photographing apparatus 100, or communicate feedback or captured images from the photographing apparatus 100 to the remote controller 110. In some embodiments, the communication circuit 101 and the communication 111 can be wireless communication circuits configured to allow the photographing apparatus 100 and the remote controller 110 to communicate with each other wirelessly. In these embodiments, the remote controller 110 further includes an antenna 112 coupled to the communication circuit 111 for transmitting and/or receiving wireless signals, as shown in FIG. 1B. The photographing apparatus 100 can also include an antenna (not shown) that is coupled to the communication circuit 101 for transmitting and/or receiving wireless signals.

As shown in FIGS. 1A and 1B, the photographing apparatus 100 includes an optical assembly 102 and a body 104. The optical assembly 102 can include, for example, an independent lens mounted on the body 104, or an integrated lens that is integrated with the body 104. The photographing apparatus 100 can be configured to capture images through the optical assembly 102. The body 104 can include a housing for accommodating various components of the photographing apparatus 100. The photographing apparatus 100 further includes a display component 105 configured to show an image and/or various indicators as described below. The display component 105 can be arranged, for example, on the body 104 as shown in FIGS. 1A and 1B, and can include, for example, a viewfinder or a screen, such as a touch screen.

In some embodiments, as shown in FIG. 1A, the photographing apparatus 100 includes a focus adjusting component 106 coupled to the optical assembly 102 and configured to adjust a focus of the optical assembly 102. In some embodiments, the focus adjusting component 106 can include a mechanical adjusting means such as a focusing ring arranged around the optical assembly 102. By turning the focusing ring, a user can change the focus of the optical assembly 102 through a series of mechanical couplings between the focusing ring and the optical assembly 102. In some other embodiments, the focus adjusting component 106 can include one or more adjusting buttons or adjusting wheels arranged on the optical assembly 102 or the body 104. When the user presses one of the one or more adjusting buttons or turns the one or more adjusting wheels, an electronic signal can be generated to indicate how the focus of the optical assembly 102 should be adjusted, e.g., to which direction and/or the distance one or more optical components of the optical assembly 102 should be moved. The electronic signal can then be used to instruct a motor installed on the optical assembly 102 or the body 104 to drive the optical assembly 102 to focus. In some embodiments, the one or more adjusting buttons or wheels can include mechanical buttons or wheels coupled to a signal generator for generating the electronic signal. In some other embodiments, the one or more adjusting buttons or wheels can include virtual buttons or wheels displayed on, for example, the display component 105 of the photographing apparatus 100.

As shown in FIG. 1B, the remote controller 110 includes a display component 113 configured to display a captured image and/or various indicators as described below. The display component 113 can include, for example, a screen, such as a touch screen.

In some embodiments, as shown in FIG. 1B, the remote controller 110 includes a focus adjusting component 114 configured to focus the optical assembly 102. The focus adjusting component 114 can be operated to trigger the remote controller 110 to send an adjusting signal to the photographing apparatus 100, which instructs the motor installed on the optical assembly 102 or the body 104 to drive the optical assembly 102 to focus. Similar to the focus adjusting component 106, the focus adjusting component 114 can include one or more mechanical buttons or wheels, or can include one or more virtual buttons or wheels displayed on, for example, the display component 113 of the remote controller 110.

In some embodiments, as shown in FIG. 1A, the photographing apparatus 100 further includes a controlling device 108, which can be arranged in the body 104 and configured as a part of the body 104. In some embodiments, the controlling device 108 can be independent of the body 104 and coupled to the body 104.

The controlling device 108 can be configured to, e.g., control an operation of the photographing apparatus 100 and/or perform a method consistent with the disclosure, such as one of the exemplary methods described below. For example, the controlling device 108 can be coupled to the one or more adjusting buttons or wheels described above and generate the electronic signal in response to the one of the one or more adjusting buttons being pressed or the one or more adjusting wheels being turned. As another example, the controlling device 108 can be coupled to the focusing ring described above and can determine a focus position, which may correspond to a current focusing value, of the optical assembly 102 by determining a turning position of the focusing ring.

In some embodiments, as shown in FIG. 1B, the remote controller 110 further includes a controlling device 116. The controlling device 116 can be configured and function in a similar manner as the controlling device 108. The controlling device 116 can be coupled to the communication circuit 111 such that instructions generated by the controlling device 116 can be communicated to the photographing apparatus 100 through the communication circuit 111.

Further, as shown in FIG. 1A, the controlling device 108 includes a memory 108-2 and a processor 108-4 coupled to the memory 108-2. The memory 108-2 stores instructions that, when executed by the processor 108-4, control the processor 108-4 to perform a method consistent with the disclosure, such as one of the exemplary methods described below. As shown in FIG. 1B, the controlling device 116 includes a memory 116-2 and a processor 116-4 coupled to the memory 116-2. The memory 116-2 stores instructions that, when executed by the processor 116-4, control the processor 116-4 to perform a method consistent with the disclosure, such as one of the exemplary methods described below.

The memory 108-2 and/or the memory 116-2 can include a non-transitory computer-readable storage medium, such as a random access memory (RAM), a read only memory, a flash memory, a hard disk storage, or an optical media. The processor 108-4 and/or the processor 116-4 can include any suitable hardware processor, such as a microprocessor, a micro-controller, a central processing unit (CPU), a graphic processing unit (GPU), a network processor (NP), a digital signal processor (DSP), an application specific integrated circuit (ASIC), a field-programmable gate array (FPGA), or another programmable logic device, discrete gate or transistor logic device, discrete hardware component.

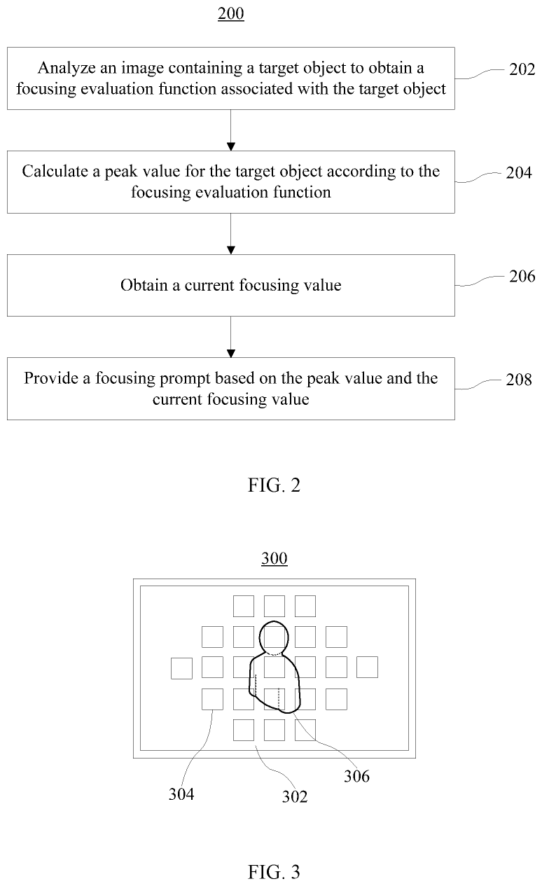

FIG. 2 is a flow chart showing an exemplary manual focus assist method 200 consistent with the disclosure. The method 200 can be implemented, for example, in the controlling device 108 or the controlling device 116 described above. According to the manual focus assist method 200, a focusing prompt indicating whether a captured image is in-focus can be provided to assist a user to determine whether a target object is in-focus.

As shown in FIG. 2, at 202, an image containing a target object is analyzed to obtain a focusing evaluation function associated with the target object, which is also referred to as a “focusing target.” The image can be captured by, e.g., the photographing apparatus 100 through the optical assembly 102. At 204, a peak value for the target object is calculated according to the focusing evaluation function. In this disclosure, the peak value for the target object is also referred to as a peak focusing value. At 206, a current focusing value is obtained. At 208, a focusing prompt is provided based on the peak value and the current focusing value.

Consistent with the disclosure, any suitable function can be used as the focusing evaluation function. In some embodiments, the focusing evaluation function can be, for example, unimodal (having only one peak value), unbiased (having a maximum value when the optical assembly is properly focused), and capable of reflecting a polarity of the off-focus (whether it is before or behind the focus), and can have a good anti-interference capability. For example, the focusing evaluation function can include a sharpness evaluation function based on, e.g., a frequency-domain analysis, the information theory, or a differential operation.

The frequency-domain analysis includes analyzing the image in a frequency domain. Usually, an in-focus image, i.e., a properly focused image having a high sharpness, includes sharper edges, e.g., edges with high contrast, and more image details as compared to an out-of-focus image. Edges and details of an image correspond to high-frequency components of a frequency-domain expression of the image. Thus, the frequency-domain expression of the out-of-focus image usually has less high-frequency components as compared to the in-focus image. Therefore, the sharpness evaluation function based on the frequency-domain expression can be used to evaluate whether an image is properly focused.

The frequency-domain expression of an image can be obtained by a transform based on Fourier transform. In determining whether the image is sharp, color information of the image may be irrelevant and a grayscale component of the image can be analyzed. For example, the grayscale component with a spatial location distribution can be converted to an expression of a spatial frequency distribution. The amount of high-frequency components in the spatial frequency distribution can be used to determine whether the image is sharp. Consistent with the disclosure, a larger amount of high-frequency components in the spatial frequency distribution indicates a sharper image.

In some embodiments, analyzing the image in the frequency domain includes analyzing the image based on discrete wavelet transform (DWT). In some other embodiments, analyzing the image in the frequency domain includes analyzing the image based on discrete cosine transform (DCT).

In the analysis of an image based on DWT, a signal representing the image can be filtered by a filter group including two complementary filters—a low-pass filter that generates an approximation A of the signal and a high-pass filter that generates a detail D of the signal. In DWT, an approximation is a coefficient generated by a large scale, which represents a low-frequency component of the signal. On the other hand, a detail is a coefficient generated by a small scale, which represents a high-frequency component of the signal. A two-dimensional (2D) image can be subject to a series of 2D DWTs to decompose image information to high-frequency components H, V, and D, and a low-frequency component A.

Wavelet focus functions involved in DWT can include a horizontal high-frequency coefficient matrix (denoted by Cₕ), a vertical high-frequency coefficient matrix (denoted by Cᵥ), and a diagonal high-frequency coefficient matrix (denoted by C_{d}), respectively. The amplitude of a low-frequency coefficient can be reduced and the amplitude of a high-frequency coefficient can be enhanced. An evaluation function can be obtained by summing the high-frequency components, as expressed below:

E=Σ_{i,j}(|Cₕ|+Cᵥ|+|C_{d}|) (1)

where Σ_{i,j} indicates a summation over the entire image or an area of interest in the image, with (i,j) representing a pixel at the cross point of the i-th column and the j-th row. A larger E indicates that the image has more high-frequency components, i.e., a more sharp change at an edge, and hence the image has a higher sharpness.

In the analysis of an image based on DCT, a digit image matrix f(i,j) can be defined for an M×N image, where M and N are positive integers representing the number of columns and the number of rows, respectively, of the image. The transform function for a pixel at location (u,v), where u=0, 1, . . . , M−1 and v=0, 1, . . . , N−1, of the image can be expressed as follows:

$$\begin{matrix}F ( u , v ) = c ( u ) c ( v ) {\sum }_{i = 0}^{M - 1} {\sum }_{j = 0}^{N - 1} f ( i , j ) cos \frac{π ( 2 i + 1 ) u}{2 M} cos \frac{π ( 2 j + 1 ) v}{2 N} & ( 2 ) \\ where \text{:} & \\ c ( u ) = \{ \begin{matrix}\sqrt{1 / M} & ( u = 0 ) \\ \sqrt{2 / M} & ( u = 1 , 2 , … , M - 1 )\end{matrix} & ( 3 ) \\ c ( v ) = \{ \begin{matrix}\sqrt{1 / N} & ( v = 0 ) \\ \sqrt{2 / N} & ( v = 1 , 2 , … , N - 1 )\end{matrix} & ( 4 )\end{matrix}$$

Using the transform function F(u ,v), the evaluation function based on DCT can be written as:

$${E}^{′} = \frac{{\sum }_{v}^{N} {\sum }_{u}^{M} \vert F ( u , v ) \vert}{\vert F ( 1 , 1 ) \vert} u + v > min ( M , N ) \qquad ( 5 )$$

An image having a larger E′ value is shaper.

A sharpness evaluation function based on information theory usually uses an amount of information, also referred to as “information entropy” or simply “entropy,” to indicate the sharpness of an image. As compared to an out-of-focus image, an in-focus image usually has a higher variety in grayscale values. That is, the out-of-focus image and the in-focus image can have different amounts of information, or different information entropies. For example, the further the image is deviated from being in-focus, the more uniform are the grayscale values of the image, i.e., the image is closer to a single-grayscale-level image. Hence, the image contains less information, i.e., the information entropy of the image is smaller. The image has the highest sharpness when the information entropy of the image reaches a maximum value. Therefore, the information entropy of an image can be determined and used as the focusing evaluation function of the image.

As described above, the color information of an image may be irrelevant during the analysis of the sharpness of the image. Therefore, when the sharpness evaluation function is calculated based on the information theory, the grayscale component of the image can be used without considering the color information of the image. As such, entropy related to the grayscale component, also referred to as “grayscale entropy,” can be used as the information entropy.

For example, for a scene to be photographed, a series of K images, where K is a positive integer, can be captured and a grayscale histogram can be calculated for each image. The probability, i.e., frequency, of a k-th image, where 1≤k≤K, having a grayscale value g can be denoted as Pₖ(g). Thus, the grayscale entropy of the k-th image can be expressed as:

Sₖ=−Θ_{g=0}^{G}Pₖ(g)logPₖ(g) (6)

where G denotes the maximum grayscale value. Thus, finding S₆₇ =max{Sₖ} gives the image, the δ-th image, that has the maximum grayscale value among the K images. That is, the δ-th image is the in-focus image.

The differential operation can determine gradients of grayscale value distribution in an image. Usually the gradient at an edge or contour of an object in the image can be larger than the gradient at other locations of the image. Further, the gradient at a sharp edge is usually larger than the gradient at a blurry edge, and an in-focus image usually has sharper edges than an out-of-focus image. Therefore, the gradients of an image can be used as the focusing evaluation function of the image. In some embodiments, for a digital image, the differential operation can include a finite difference operation to calculate gradients in the image, and a sum of the absolute values of the gradients, also referred to as a “grayscale difference” can be obtained as the focusing evaluation function of the image. The operator used in the differential operation can include, for example, a Roberts operator or a Sobel operator.

In some embodiments, image analysis can be performed in a region of a field of view (FOV) of the photographing apparatus 100. This region is also referred to as a “focusing region” of the photographing apparatus 100. In some embodiments, the photographing apparatus 100 can include a plurality of focusing regions arranged in a pattern, for example, as an array. FIG. 3 schematically shows an exemplary display component 300, from which an exemplary FOV 302 of the photographing apparatus 100 can be viewed. The display component 300 can be, for example, the display component 105, e.g., a viewfinder or a screen, of the photographing apparatus 100, or the display component 113, e.g., a screen, of the remote controller 110. As shown in FIG. 3, a plurality of focusing regions 304 are arranged in an array in the FOV 302.

Any one or more of the focusing regions 304 can be used for the image analysis consistent with the disclosure, for example, with respect to a target object 306 in the FOV 302. In some embodiments, a user can select one or more focusing regions 304 for the image analysis, such as one or more focusing regions 304 that overlap a target object 306. For example, the user can select the one or more focusing regions 304 by operating a selection mechanism, e.g., a button or a wheel, provided on the photographing apparatus 100 or the remote controller 110 that controls the photographing apparatus 100. As another example, the user can select the one or more focusing regions 304 by touching one or more corresponding locations on a touch screen of the photographing apparatus 100 or the remote controller 110. The selected one or more focusing regions 304 can be highlighted to indicate that they correspond to the focusing target 306. Hence a selected focusing region 304 can also be referred to as a “target indicating frame.”

FIG. 3 shows, as one example, the pre-defined focusing regions having fixed locations in the FOV 302 and fixed sizes. In some other embodiments, a focusing region of the photographing apparatus 100 may be at any location in the FOV 302 and have any size. For example, the user can touch a desired place on the touch screen of the photographing apparatus 100 or the remote controller 110 to trigger a focusing region located at the desired place. A frame can be displayed at the desired place to indicate the user's selection and serve as a target indicating frame.

The target indicating frame can have any suitable shape, such as a circular shape or a polygonal shape. When the target indicating frame has a circular shape, it can also be referred to as a “target indicating ring.” In the example shown in FIG. 3, the target indicating frame has a square shape as shown in FIG. 3. The target indicating frame can have another polygonal shape, such as a triangular shape or a rectangular shape.

In general, a point associated with a focusing region, such as a midpoint of the focusing region can be referred to as a “focusing point.” In some embodiments, a focusing region may be very small and the focusing region itself can be close to a point and thus be referred to as the focusing point.

After the focusing evaluation function associated with the target object is obtained, the peak value for the target object can be calculated according to the focusing evaluation function (204 in FIG. 2). The peak value is a reference for indicating when the image of the target object is in-focus. In some embodiments, the peak value can be the maximum value of the focusing evaluation function. In some other embodiments, the peak value can be associated with a variable of the focusing evaluation function or be associated with a parameter corresponding to the variable of the focusing evaluation function. The peak value can correspond to a value of the variable at which the focusing evaluation function reaches a maximum value. For example, the peak value may indicate a distance from the target object to the photographing apparatus 100. This distance is also referred to as a “target focusing distance.” As another example, the peak value may indicate a target object distance (target distance from the target object to an optical center of the optical assembly 102) or a target image distance (target distance from the optical center of the optical assembly 102 to an imaging plane, such as a surface of a photo sensor, of the photographing apparatus 100).

Further, the current focusing value can be obtained (206 in FIG. 2) using any suitable approach. Generally, the current focusing value can change in response to the focus adjusting component 106 or the focus adjusting component 114 adjusting the focus of the optical assembly 102. For example, in the embodiments that the focus adjusting component 106 includes a focusing ring on the optical assembly 102, the current focusing value can change while the focusing ring is turned, and the current focusing value can reflect the turning position of the focusing ring. As another example, in the embodiments that the focus adjusting component 106 or the focus adjusting component 114 includes an adjusting wheel, the current focusing value can change while the adjusting wheel is turned, and the current focusing value can reflect a turning position of the adjusting wheel.

In some embodiments, the current focusing value can be obtained directly based on a feedback from the focus adjusting component 106 or the focus adjusting component 114. In some embodiments, the current focusing value can be calculated based on the focusing evaluation function. Similar to the peak value, in some embodiments, the current focusing value can be a value calculated using the focusing evaluation function according to an image captured with current focus adjusting parameters. In some other embodiments, the current focusing value can be associated with the variable of the focusing evaluation function or be associated with the parameter corresponding to the variable of the focusing evaluation function. For example, the current focusing value may indicate a current focusing distance of the photographing apparatus 100. That is, if an imaginary object were placed in front of the photographing apparatus 100 and the distance between the imaginary object and the photographing apparatus 100 equaled the current focusing distance, an image of the imaginary object captured by the photographing apparatus 100 would have been sharp. Causing the photographing apparatus 100 to focus on the target object is to adjust the optical assembly 102 such that the current focusing distance equals the target focusing distance. As another example, the current focusing value may indicate a current object distance (current distance from the imaginary object to the optical center of the optical assembly 102) or a current image distance (current distance from the optical center of the optical assembly 102 to the imaging plane, such as the surface of the photo sensor, of the photographing apparatus 100). Causing the photographing apparatus 100 to focus on the target object is to adjust the optical assembly 102 such that the current object distance equals the target object distance or that the current image distance equals the target image distance.

After the peak value and the current focusing value are obtained, the focusing prompt can be provided based on the peak value and the current focusing value (208 in FIG. 2). The focusing prompt can indicate to a user whether the photographing apparatus 100 (specifically the optical assembly 102) is properly focusing on the target object, e.g., whether the current focusing value equals the peak value, and/or how much the off-focus is, e.g., what the difference between the current focusing value and the peak value is.

According to the present disclosure, the focusing prompt can be provided in one of various forms. For example, the focusing prompt can be provided in a visual form, an acoustic form, or a mechanical form, as set forth in the embodiments described in more detail below.

The focusing prompt can be visually presented on the display component described above, e.g., a view finder of the photographing apparatus 100 or a screen on the photographing apparatus 100 or the remote controller 110. In the embodiments that the focusing prompt is displayed on the screen, the image captured by the photographing apparatus 100 can also be displayed on the screen at the same time as the focusing prompt, and the focusing prompt can overlie or superimpose over the displayed image. As such, while operating the focus adjusting component 106, 114 to change the focus of the photographing apparatus 100, the user can both view the image and observe the focusing prompt to determine whether the image is in-focus.

In some embodiments, visually presenting the focusing prompt can include displaying a peak indicator representing the peak value on the display component and displaying a current-focus indicator representing the current focusing value on the display component. A distance between the peak indicator and the current-focus indicator on the display component, also referred to as an “indicator distance,” can correlate to a difference between the peak value and the current focusing value, also referred to as a “focusing value difference.” For example, the indicator distance can be proportional to the focusing value difference.

As described above, the current focusing value can be adjusted by the focus adjusting component 106, 114. In some embodiments, the current focusing value can be correlated to an adjustment position of the focus adjusting component 106, 114. The adjustment position may refer to a position within an adjustment range of the focus adjusting component 106, 114. For example, in the scenario that the focus adjusting component 106, 114 includes the focusing ring or the adjusting wheel, the adjustment position can be the turning position of the focusing ring or the turning position of the adjusting wheel.

Therefore, a change of the indicator distance can be correlated to a change of the adjustment position of the focus adjusting component 106, 114. The change of the adjustment position is also referred to as an “adjustment amount.” In some embodiments, the change of the indicator distance can be proportional to the adjustment amount of the focus adjusting component 106, 114, i.e., the indicator distance can change uniformly with the adjustment amount, i.e., with changing the adjustment position. For example, if the focus adjusting component 106 includes the focusing ring on the optical assembly 102, the adjustment amount can include a degree of an angle for which the focusing ring has turned, also referred to as a “turning angle” of the focusing ring. In this example, the change of the indicator distance can be proportional to the turning angle of the focusing ring, i.e., the indicator distance can change uniformly with the turning angle.

In some other embodiments, the indicator distance can change non-uniformly with the adjustment amount of the focus adjusting component 106, 114. For example, the closer is the current-focus indicator to the peak indicator, i.e., the smaller is the difference between the peak value and the current focusing value, the larger change can a same adjustment amount cause in the indicator distance. In the scenario that the focus adjusting component 106, 114 includes the focusing ring, the indicator distance can change non-uniformly when the focusing ring is being turned. For example, the closer is the current-focus indicator to the peak indicator, the larger change can a same turning angle cause in the indicator distance.

In some embodiments, the non-uniform change of the indicator distance with the adjustment amount may be continuous. That is, the amount of the change of the indicator distance caused by the same adjustment amount, also referred to as a “changing rate” of the indicator distance, can change gradually with the indicator distance, e.g., increase gradually when the current-focus indicator approaches the peak indicator.

In some other embodiments, the non-uniform change of the indicator distance with the adjustment amount may be non-continuous. That is, the changing rate of the indicator distance can remain constant within a certain range of the indicator distance and then change to another rate in another range. For example, a plurality of changing rates can be set for a plurality of ranges of the indicator distance. In each range of the indicator distance, the changing rate can be the same, i.e., the indicator distance can change uniformly with the adjustment amount. However, in different ranges of the indicator distance, the changing rates can be different. The closer is the indicator distance to zero, i.e., the closer is the current-focus indicator to the peak indicator, the larger is the changing rate.

The nonuniform change of the indicator distance with the adjustment amount can increase a sensitivity of the focus adjustment component 106, 114, especially when the current-focus indicator is close to the peak indicator. For example, in the scenario that the focus adjustment component 106, 114 includes the focusing ring or the adjusting wheel, when it is close to being in-focus, a small change in the turning position of the focusing ring or the adjusting wheel, i.e., a small turning angle, may result in a relatively large change in the indicator distance. As such, the user can more clearly observe the change of the focusing position. Accordingly, a focusing accuracy can be improved.

In some embodiments, in addition to or in alternative to the nonuniform change of the indicator distance with the adjustment amount, the focusing distance can also change non-uniformly with the adjustment amount of the focus adjusting component 106, 114. For example, the closer is the current-focus indicator to the peak indicator, i.e., the smaller is the difference between the peak value and the current focusing value, the smaller change can a same adjustment amount cause in the focusing distance. In the scenario that the focus adjusting component 106, 114 includes the focusing ring, the focusing distance can change non-uniformly when the focusing ring is being turned. For example, the closer is the current-focus indicator to the peak indicator, the larger change can a same turning angle cause in the focusing distance.

Similar to the indicator distance change scenario, the non-uniform change of the focusing distance with the adjustment amount may be continuous or non-continuous. In the continuous scenario, the amount of the change of the focusing distance caused by the same adjustment amount, i.e., the changing rate of the focusing distance, can change gradually with the indicator distance (or with the focusing value difference), e.g., decreases gradually when the current-focus indicator approaches the peak indicator.

In the non-continuous scenario, the changing rate of the focusing distance can remain constant within a certain range of the indicator distance (or within a certain range of the focusing value difference) and then change to another rate in another range. For example, a plurality of changing rates can be set for a plurality of ranges of the indicator distance (or for a plurality of ranges of the focusing value difference). In each range of the indicator distance (or in each range of the focusing value difference), the changing rate can be the same, i.e., the focusing distance can change uniformly with the adjustment amount. However, in different ranges of the indicator distance (or in different ranges of the focusing value difference), the changing rates can be different. The closer is the indicator distance to zero, i.e., the closer is the current-focus indicator to the peak indicator, the smaller is the changing rate.

The nonuniform change of the focusing distance with the adjustment amount can allow a fine tune when the current focusing value is close to the peak value. For example, in the scenario that the focus adjustment component 106, 114 includes the focusing ring or the adjusting wheel, when it is closer to being in-focus, to result in a same change of the focusing distance, a larger change in the turning position of the focusing ring or the adjusting wheel, i.e., a larger turning angle. As such, the user can more finely adjust the focusing distance. Accordingly, a focusing accuracy can be improved.

The change of the focusing distance can be achieved by the movement of the optical components of the optical assembly 102. The correlation between the movement amount of the optical components and the adjustment amount of the focus adjustment component 106, 114 can be referred to as a “transmission ratio,” i.e., the ratio of the movement amount to the adjustment amount. The transmission ratio can be changed both electrically (e.g., when the focus adjustment component 106, 114 includes the one or more adjusting buttons or wheels), mechanically (e.g., when the focus adjustment component 106 includes the focusing ring), or both electrically and mechanically. In some embodiments, the smaller is the indicator distance, i.e., the smaller is the focusing value difference, the smaller can the transmission ratio be.

The peak indicator and the current-focus indicator can be displayed at any suitable locations on the display component, such as in the middle portion, the upper portion, the lower portion, the left portion, the right portion, the upper left portion, the lower left portion, the upper right portion, or the lower right portion of the display component.

In some embodiments, the target indicating frame is also displayed on the display component along with the peak indicator and the current-focus indicator. In these embodiments, one or both of the peak indicator and the current-focus indicator can be arranged in a portion of the display component that overlaps the target indicating frame. For example, one or both of the peak indicator and the current-focus indicator can be arranged outside the target indicating frame but close to the target indicating frame. In other examples, one or both of the peak indicator and the current-focus indicator can be arranged on the target indicating frame or inside the target indicating frame. Arranging one or both of the peak indicator and the current-focus indicator in, on, or close to the target indicating frame can allow the user to focus on both the target object and the focusing prompt, without the need to look at a different place to check whether the photographing apparatus 100 has properly focused on the target object.

In some embodiments, the peak indicator can be arranged at a selected location on the display component, such as one of the above-described locations. The selected location can be a pre-set fixed location on the display component or can be a location selected by the user. For example, the selected location can correspond to a region on the display component that contains the target object and the target indicating frame can also be displayed and arranged at the selected location.

The current-focus indicator can be displayed at one of two opposite sides of the selected location to indicate whether the current focusing value is larger than or smaller than the peak value. For example, if the current focusing value is smaller than the peak value, the current-focus indicator can be displayed to a first side, e.g., a left side or a lower side, of the selected location. If the current focusing value is larger than the peak value, the current-focus indicator can be displayed to a second side, e.g., a right side or an upper side, of the selected location. Further, if the current focusing value is the same as the peak value, the current-focus indicator can also be displayed at the selected location, i.e., the current-focus indicator and the peak indicator overlap each other.

In some embodiments, the current focusing value being smaller than the peak value may be associated with the scenario that the current adjustment position of the focus adjusting component 106, 114, e.g., the current turning position of the focusing ring or the adjusting wheel, corresponds to a focusing distance smaller than the distance from the target object to the photographing apparatus 100, i.e., the target focusing distance. Correspondingly, the current focusing value being larger than the peak value may be associated with the scenario that the current adjustment position of the focus adjusting component 106, 114, e.g., the current turning position of the focusing ring or the adjusting wheel, corresponds to a focusing distance larger than the target focusing distance. Further, the current focusing value being the same as the peak value may be associated with the scenario that the current adjustment position of the focus adjusting component 106, 114, e.g., the current turning position of the focusing ring or the adjusting wheel, corresponds to a focusing distance equaling the target focusing distance.

In some embodiments, the focusing prompt can include a scale displayed on the screen. The peak indicator can be arranged at a fixed position on the scale and the current-focus indicator can move along the scale while the focus adjusting component 106, 114 adjusts the focus of the photographing apparatus 100 to change the current focusing value. The scale can be placed at a suitable position on the screen and have a suitable size. For example, the scale can be arranged in such a manner that the peak indicator is positioned at the selected location described above.

The scale can adopt one of various suitable forms. For example, the scale can include a curved line segment, such as a semi-circle. As another example, the scale can include a straight line segment.

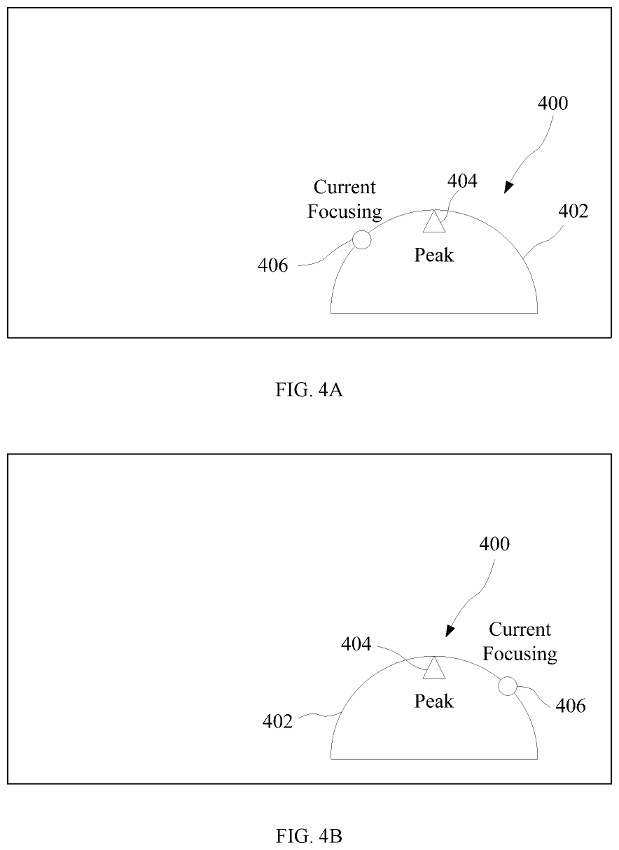

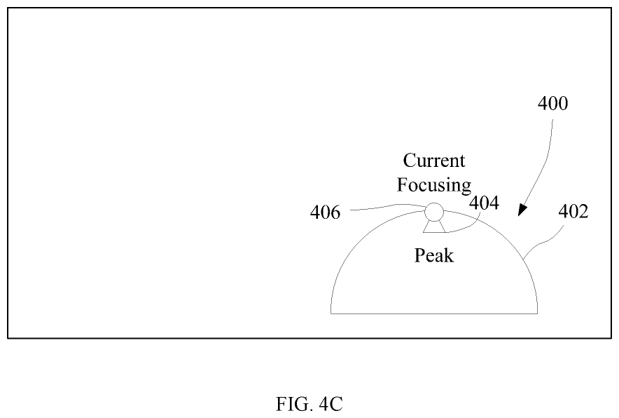

FIGS. 4A-4C schematically show an exemplary visual focusing prompt 400 consistent with embodiments of the disclosure. The focusing prompt 400 is displayed in a display region (region enclosed by the solid outer frame in FIGS. 4A-4C) of the display component, which can be, for example, a liquid crystal display panel. As shown in FIGS. 4A-4C, the focusing prompt 400 includes a scale 402 having a semi-circular shape, a peak indicator 404 arranged at a middle point of the scale 402, and a current-focus indicator 406 arranged on the scale 402 at a position determined according to the difference between the current focusing value and the peak value.

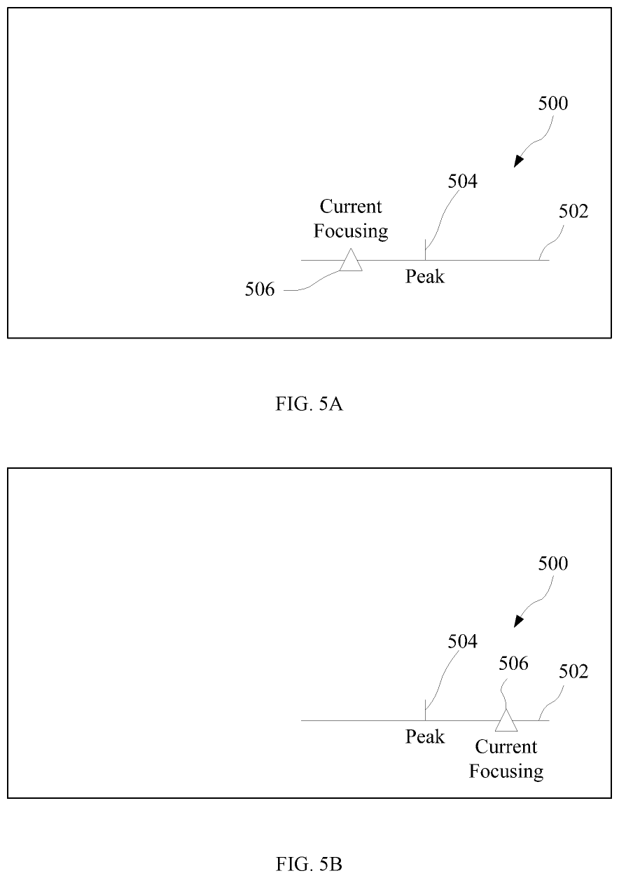

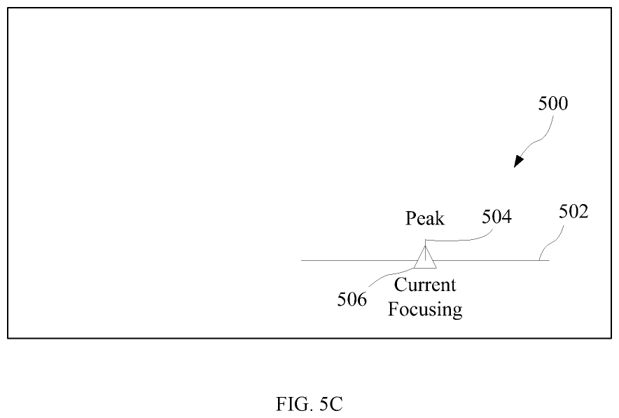

Similarly, FIGS. 5A-5C schematically show another exemplary visual focusing prompt 500 consistent with embodiments of the disclosure. The focusing prompt 500 is displayed in a display region (region enclosed by the solid outer frame in FIGS. 5A-5C) of the display component, which can be, for example, a liquid crystal display panel. As shown in FIGS. 5A-5C, the focusing prompt 500 includes a scale 502 having a straight line segment shape, a peak indicator 504 arranged at a middle point of the scale 502, and a current-focus indicator 506 arranged on the scale 502 at a position determined according to the difference between the current focusing value and the peak value.

FIGS. 4A and 5A show the situation in which the current focusing value is smaller than the peak value. In this situation, the current-focus indicator 406, 506 is displayed at a first portion of the scale 402, 502 that is on a first side of the middle point, e.g., the left portion of the scale 402, 502 on the left side of the middle point.

FIGS. 4B and 5B show the situation in which the current focusing value is larger than the peak value. In this situation, the current-focus indicator 406, 506 is displayed at a second portion of the scale 402, 502 that is on a second side of the middle point, e.g., the right portion of the scale 402, 502 on the right side of the middle point.

FIGS. 4C and 5C show the situation in which the current focusing value equals the peak value. In this situation, the current-focus indicator 406, 506 is displayed at the middle point of the scale 402, 502, i.e., the current-focus indicator 406, 506 overlaps the peak indicator 404, 504.

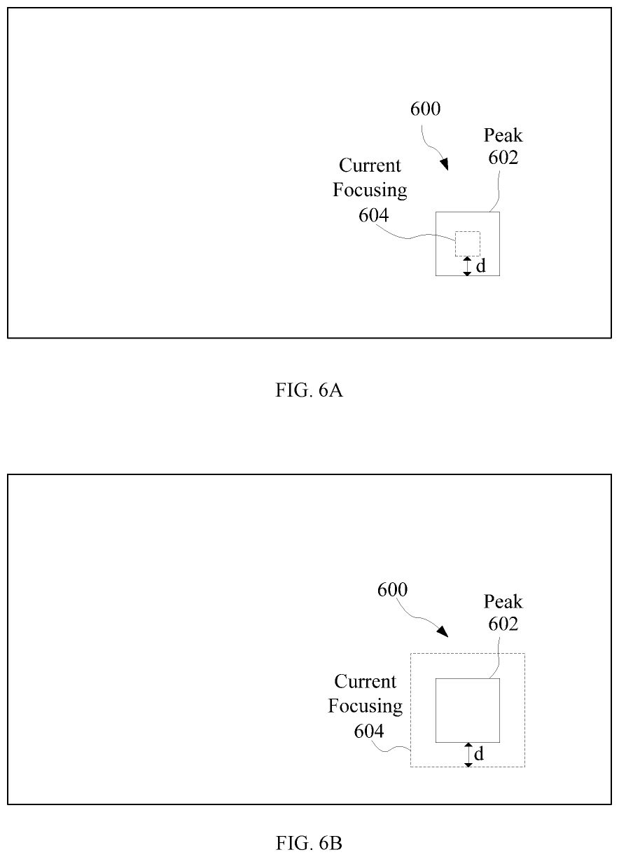

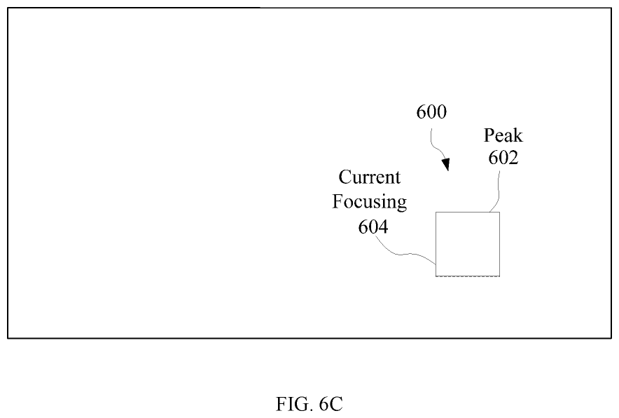

FIGS. 6A-6C schematically show another exemplary visual focusing prompt 600 consistent with embodiments of the disclosure. The focusing prompt 600 is displayed in a display region (region enclosed by the solid outer frame in FIGS. 6A-6C) of the display component, which can be, for example, a liquid crystal display panel. As shown in FIGS. 6A-6C, the focusing prompt 600 includes a first frame 602 serving as the peak indicator and a second frame 604 serving as the current-focus indicator. In some embodiments, as shown in FIGS. 6A-6C, a center point of the first frame 602 and a center point of the second frame 604 overlap each other, i.e., the first frame 602 and the second frame 604 are concentric with each other.

In some embodiments, during the manual focusing process, the size of the first frame 602 does not change and the size of the second frame 604 can change while the focus adjusting component 106, 114 changes the focus of the photographing apparatus 100. The indicator distance in the embodiment shown in FIGS. 6A-6C can refer to a distance between two parallel sides of the first frame 602 and the second frame 604, for example, as indicated by letter “d” in FIGS. 6A and 6B. In FIG. 6C, the indicator distance d is zero. In the embodiment shown in FIGS. 6A-6C, the relationship between the change of the indicator distance d and the adjustment amount of the focus adjusting component 106, 114 can be the same as that described above. That is, the indicator distance d in FIGS. 6A-6C can change uniformly or non-uniformly with the adjustment amount and, in the non-uniform change scenario, can have a continuous or a non-continuous changing rate.

FIG. 6A shows the situation in which the current focusing value is smaller than the peak value. In this situation, the second frame 604, i.e., the current-focus indicator, is displayed inside the first frame 602, i.e., the peak indicator.

FIG. 6B shows the situation in which the current focusing value is larger than the peak value. In this situation, the second frame 604 is displayed to encircle the first frame 602.

FIG. 6C shows the situation in which the current focusing value equals the peak value. In this situation, the second frame 604 is displayed to overlap the first frame 602.

In the embodiment shown in FIGS. 6A-6C, the size of the second frame being smaller than the size of the first frame indicates that the current focusing value is smaller than the peak value and the size of the second frame being larger than the size of the first frame indicates that the current focusing value is larger than the peak value. In some other embodiments, this corresponding relationship can be reversed. That is, in those embodiments, the size of the second frame being smaller than the size of the first frame can indicate that the current focusing value is larger than the peak value and the size of the second frame being larger than the size of the first frame can indicate that the current focusing value is smaller than the peak value.

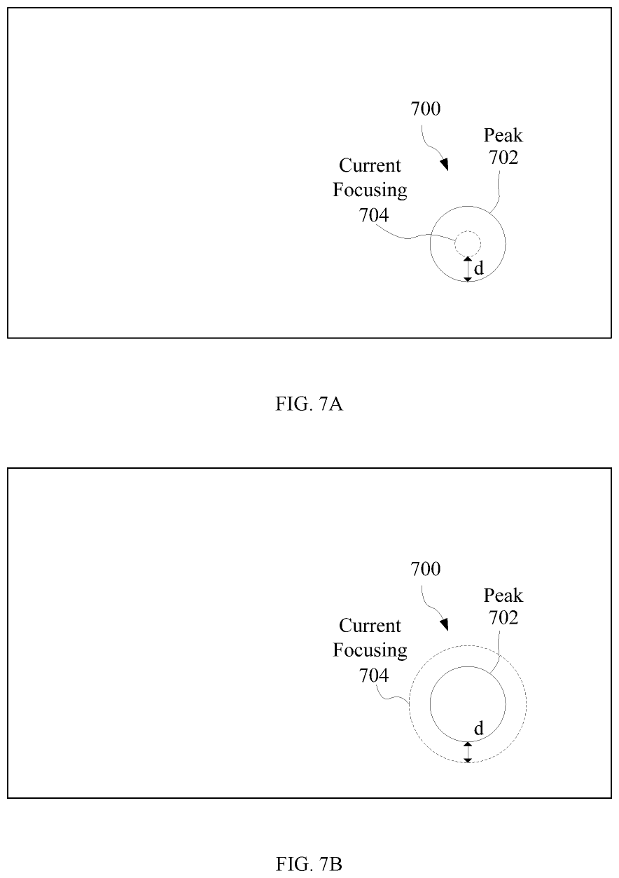

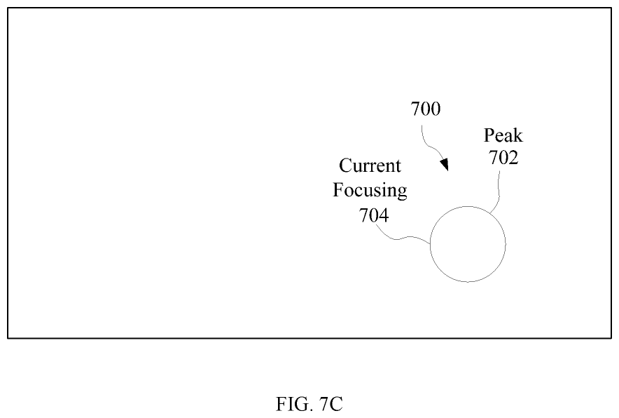

In the embodiment shown in FIGS. 6A-6C, the peak indicator and the current-focus indicator are represented by square-shaped frames. In some other embodiments, the frames serving as the peak indicator and the current-focus indicator can have one of other shapes, such as a rectangular shape, a triangular shape, or a circular shape. FIGS. 7A-7C schematically show another exemplary visual focusing prompt 700 consistent with embodiments of the disclosure. The focusing prompt 700 is displayed in a display region (region enclosed by the solid outer frame in FIGS. 7A-7C) of the display component, which can be, for example, a liquid crystal display panel. As shown in FIGS. 7A-7C, the focusing prompt 700 includes a first circular-shaped frame 702, also referred to as a first ring, serving as the peak indicator, and a second circular-shaped frame 704, also referred to as a second ring, serving as the current-focus indicator. In some embodiments, as shown in FIGS. 7A-7C, the first ring 702 and the second ring 704 are concentric with each other. The indicator distance in the embodiment shown in FIGS. 7A-7C can refer to a difference between the radii of the first and second rings.

Similar to FIGS. 6A-6C, FIGS. 7A-7C, which show the second ring 702 being inside, encircling, and overlapping the first ring, respectively, correspond to the situations in which the current focusing value is smaller than, is larger than, and equals the peak value, respectively.

In some other embodiments, the size-value corresponding relationship shown in FIGS. 6A-6C and 7A-7C can be reversed such that a larger second frame or ring corresponds to a smaller current focusing value. That is, the second frame or ring being inside and encircling the first frame or ring can correspond to the situations in which the current focusing value is larger than and smaller than the peak value, respectively.

In some embodiments, the first frame 602 shown in FIGS. 6A-6C can be the target indicating frame, i.e., the target indicating frame can serve as the first frame 602. Similarly, the first ring 702 shown in FIGS. 7A-7C can be the target indicating ring, i.e., the target indicating ring can serve as the first ring 702. In some embodiments, when a certain amount of time has elapsed after the manual focusing process is completed, i.e., after the photographing apparatus 100 is properly focused (e.g., after the current focusing value is caused to equal the peak value as indicated by, e.g., the first frame 602 and the second frame 604 overlapping each other or the first ring 702 and the second ring 704 overlapping each other), the second frame 604 or the second ring 704 can be eliminated, i.e., the second frame 604 or the second ring 704 can be caused to disappear. That is, the second frame 604 or the second ring 704 can disappear after the current focus value has been caused to equal the peak value for the certain amount of time. The certain amount of time can be, for example, about one second, about two seconds, or about three seconds, etc.

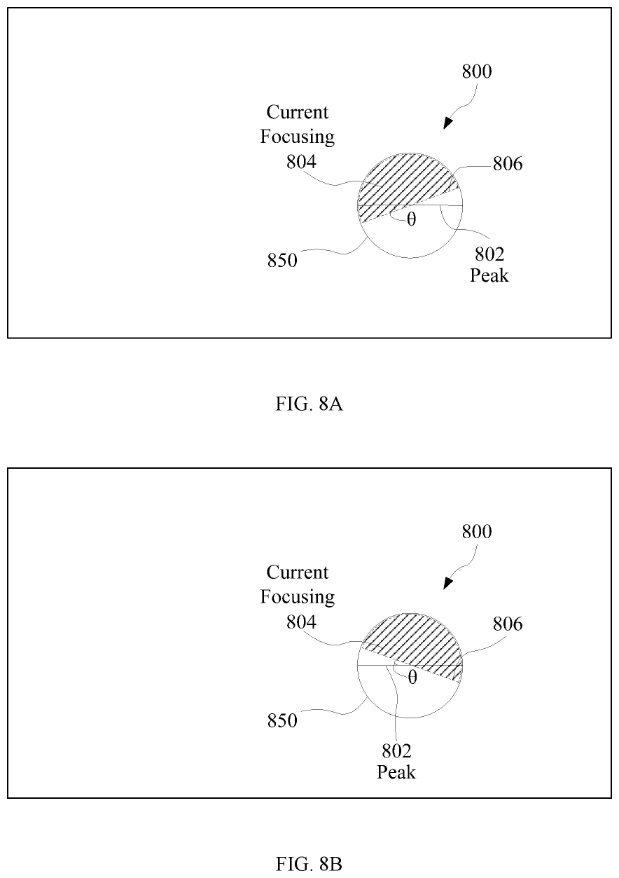

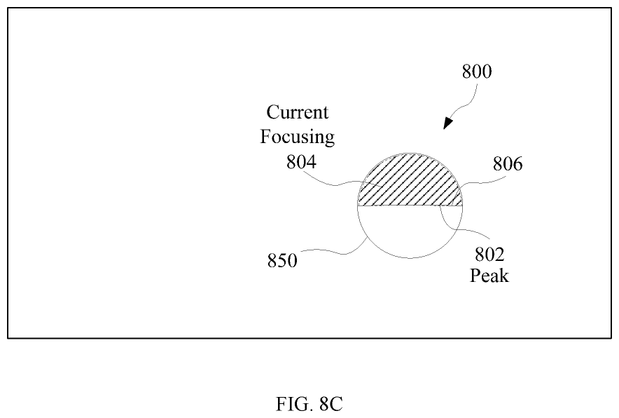

FIGS. 8A-8C schematically show another exemplary visual focusing prompt 800 consistent with embodiments of the disclosure. The focusing prompt 800 is displayed in a display region (region enclosed by the solid outer frame in FIGS. 8A-8C) of the display component, which can be, for example, a liquid crystal display panel. As shown in FIGS. 8A-8C, the focusing prompt 800 includes a line segment 802 serving as the peak indicator and a semi-circle 804 serving as the current-focus indicator. In some embodiments, as shown in FIGS. 8A-8C, a middle point of the line segment 802 and a circle center of the semi-circle 804 overlap each other.

In the embodiment shown in FIGS. 8A-8C, the semi-circle 804 can rotate about its circle center when the focus adjusting component 106, 114 is operated to change the focus of the photographing apparatus 100, i.e., to change the current focusing value. The indicator distance in the embodiment shown in FIGS. 8A-8C can be represented by an angle, θ, between a bottom side 806 of the semi-circle 804 and the line segment 802. Similar to the embodiments described above, the indicator distance θ in FIGS. 8A-8C can change uniformly or non-uniformly with the adjustment amount of the focus adjusting component 106, 114 and, in the non-uniform change scenario, can have a continuous or a non-continuous changing rate.

In FIG. 8A, the semi-circle 804 is tilted in a counter-clockwise direction for the angle θ with respect to the line segment 802, i.e., the semi-circle 804 tilts to the left. FIG. 8A corresponds to the situation in which the current focusing value is smaller than the peak value.

In FIG. 8B, the semi-circle 804 is tilted in a clockwise direction for the angle θ with respect to the line segment 802, i.e., the semi-circle 804 tilts to the right. FIG. 8B corresponds to the situation in which the current focusing value is larger than the peak value.

In FIG. 8C, the bottom side 806 of the semi-circle 804 overlaps the line segment 802. FIG. 8C corresponds to the situation in which the current focusing value equals the peak value.

In some other embodiments, the tilting-value relationship described above can be reversed. That is, the semi-circle tilting in the counter-clockwise direction and in the clockwise direction can correspond to the situations in which the current focusing value is larger than and smaller than the peak value, respectively.

In the embodiments that the focus adjusting component 106 includes the focusing ring on the optical assembly 102, the tilting or rotation of the semi-circle 804 can be linked to the rotation of the focusing ring. For example, a clockwise turning of the focusing ring can cause the semi-circle 804 to rotate clockwise. Correspondingly, a counter-clockwise turning of the focusing ring can cause the semi-circle 804 to rotate counter-clockwise. This provides a better visual presentation to the user as to how the focusing ring is turned and how much the focusing ring needs to be turned to focus on the target object. As such, user experience can be improved.

In some embodiments, as shown in FIGS. 8A-8C, the focusing prompt 800 can be arranged at the location corresponding to a target indicating ring 850. The radius of the semi-circle 804 can be approximately the same as or slightly smaller than the radius of the target indicating ring 850. As described above, arranging the focusing prompt 800 and the target indicating ring 850 at a same location can allow the user to focus on both the target object and the focus adjusting at the same time, without being distracted by the need to check another portion of the display region for the focusing prompt 800.

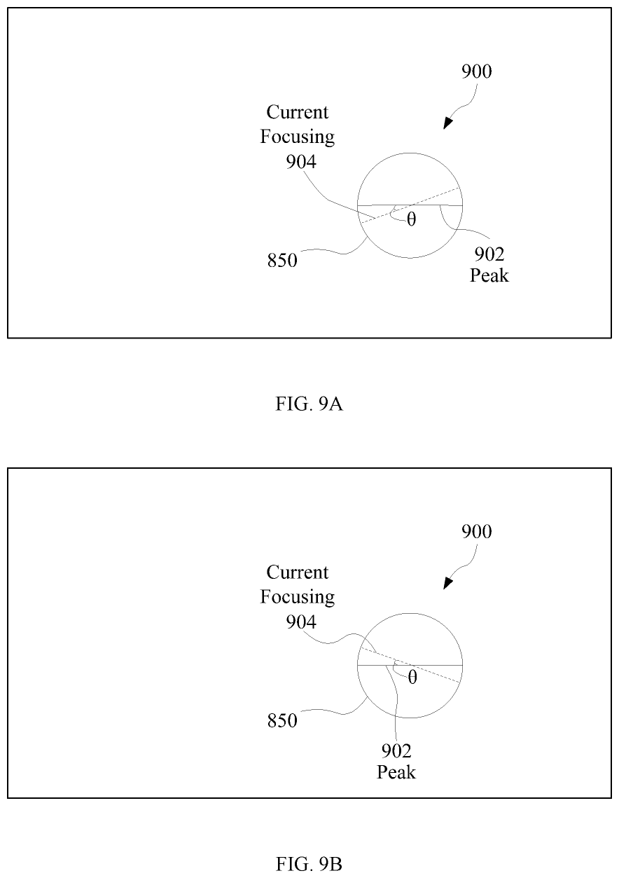

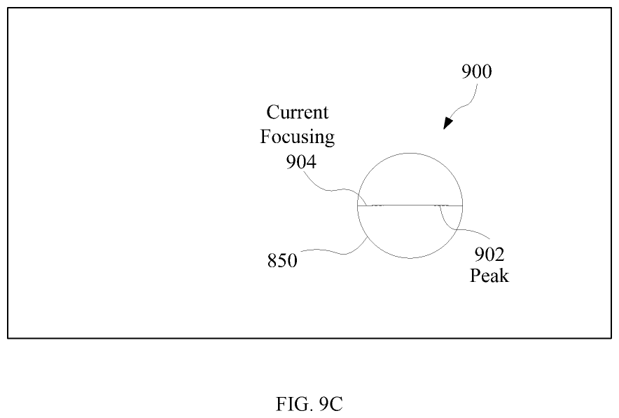

FIGS. 9A-9C schematically show another exemplary visual focusing prompt 900 consistent with embodiments of the disclosure. The focusing prompt 900 is displayed in a display region (region enclosed by the solid outer frame in FIGS. 9A-9C) of the display component, which can be, for example, a liquid crystal display panel. As shown in FIGS. 9A-9C, the focusing prompt 900 includes a first line segment 902 serving as the peak indicator and a second line segment 904 serving as the current-focus indicator. In some embodiments, as shown in FIGS. 9A-9C, a middle point of the first line segment 902 and a middle point of the second line segment 904 overlap each other.

The focusing prompt 900 is similar to the focusing prompt 800 and operates in a similar manner, except that the focusing prompt 900 uses two line segments to represent the peak value and the current focusing value, respectively, rather than one line segment and one semi-circle. Therefore, detailed description of the focusing prompt 900 is omitted.

In the embodiments described above with reference to FIGS. 4A-9C, the display component can include, for example, either a viewfinder of the photographing apparatus 100, or a screen of the photographing apparatus 100 or the remote controller 110. As described above, when the display component includes the screen of the photographing apparatus 100 or the remote controller 110, the image captured by the photographing apparatus 100 that contains the target object can be displayed on the screen simultaneously with the focusing prompt and/or the target indicating frame. That is, the peak indicator and the current-focus indicator can overlie or superimpose over the image. As such, the user can view the image at the same time while adjusting the focus, and can easily observe the results of the focus adjustment. Therefore, user experience can be improved.

After the manual focusing process is completed, i.e., after the current focusing value is adjusted to equal the peak value as indicated by, e.g., the peak indicator and the current-focus indicator overlapping each other, the user may not wish to see a portion of the focusing prompt or the entire focusing prompt. Therefore, in some embodiments, for any of the examples of focusing prompt described above with reference to FIGS. 4A-9C, after a certain amount of time has elapsed since the manual focusing process is completed, i.e., since the time point at which the photographing apparatus 100 properly focuses on the target object (e.g., the time point at which the current focusing value is caused to equal to the peak value, the peak indicator and/or the current-focus indicator can be eliminated, i.e., the peak indicator and/or the current-focus indicator can be caused to disappear. That is, the peak indicator and/or the current-focus indicator can disappear after the current focus value has been caused to equal the peak value for the certain amount of time. The certain amount of time can be, for example, about one second, about two seconds, or about three seconds, etc.

As described above, in some embodiments, the target indicating frame can also be displayed on the display component during the manual focusing process. In some embodiments, after the manual focusing process is completed and a certain amount of time has elapsed, the target indicating frame can also be eliminated, i.e., the target indicating frame can also be caused to disappear. That is, the target indicating frame can disappear after the current focus value has been caused to equal the peak value for the certain amount of time. Similarly, this certain amount of time can be, for example, about one second, about two seconds, or about three seconds, etc.

Sometimes, when the photographing apparatus 100 moves, e.g., when the photographing apparatus 100 turns in a direction for a certain degree or moves translationally for a certain distance, the selected focusing region may no longer overlap the target object and hence the peak value may no longer be valid. This may indicate that the user wishes to focus on a different target object or that the user wishes to change the composition of the image but still focus on the same target object. In the former scenario, the same focusing region may be used but a new peak value may need to be calculated. In the latter scenario, a different focusing region now corresponding to the target object may need to be selected and a new peak value may need to be calculated. Sometimes, when the photographing apparatus 100 moves along the line connecting the photographing apparatus 100 and the target object, the selected focusing region may still overlaps the target object but the distance between the photographing apparatus 100 and the target object may have changed. Therefore, a new peak value may also need to be calculated.

In these embodiments, when the photographing apparatus 100 moves, the display of the peak indicator may be ceased and then be resumed after the new peak value is calculated according to one of the methods in process 204 as described above. That is, the peak indicator may temporarily disappear until the new peak value is calculated. In some embodiments, the current-focus indicator may also temporarily disappear until the new peak value is calculated. The indicator distance after the display of the indicator(s) is resumed may be different from the previous indicator distance, depending on whether the new peak value is the same as the previous peak value.

Various techniques can be used to detect the movement of the photographing apparatus 100. In some embodiments, the photographing apparatus 100 includes a motion sensor, which can be used to detect whether the photographing apparatus 100 has moved. The motion sensor may include, for example, a gyro, an accelerometer, and/or an inertial measurement unit. In some embodiments, the movement of the photographing apparatus 100 can be detected according to an image processing method. For example, whether the photographing apparatus 100 has moved can be detected by detecting whether the image shown on the display region of the display component has moved relative to the display region.

The visual focusing prompts described above with reference to FIGS. 4A-9C are merely examples of visual focusing prompts consistent with embodiments of the disclosure. A visual focusing prompt according to the disclosure can also include one of various other forms. For example, the visual focusing prompt can include a plurality of light-emitting devices (LEDs) arranged on the photographing apparatus 100 or the remote controller 110. For example, the LEDs can be arranged within the display region of the display component, or be arranged outside but near the display region.

In some embodiments, the focusing prompt can include three LEDs arranged in a horizontal line or in a vertical line. When the current focusing value is smaller than the peak value, the left one of the horizontally arranged LEDs or the lower one of the vertically arranged LEDs can be turned on. When the current focusing value is larger than the peak value, the right one of the horizontally arranged LEDs or the upper one of the vertically arranged LEDs can be turned on. When the current focusing value equals the peak value, the middle one of the LEDs can be turned on.

In some other embodiments, the focusing prompt can include more than three LEDs arranged in a horizontal line or in a vertical line. Which one of the LEDs is turned on not only depends on whether the current focusing value is smaller than, larger than, or equal to the peak value, but also depends on the focusing value difference between the current focusing value and the peak value. The larger is the focusing value difference, the LED that is further away from the middle one of the LEDs can be turned on.

In addition to or in alternative to the exemplary visual focusing prompt described above, the visual focusing prompt can include one or more numbers displayed on or near the display region of the display component. The one or more numbers can be referred to as “focus indicating numbers.” For example, a negative number can be displayed if the current focusing value is smaller than the peak value, a positive number can be displayed if the current focusing value is larger than the peak value, and a number 0 can be displayed if the current focusing value equals the peak value. In some embodiments, an absolute value of the negative number or the positive number can correspond to or represent the difference between the peak value and the current focusing value, but does not have to be the exact difference between the peak value and the current focusing value.

The form of the focus indicating number can be different depending on what type of focus adjusting component 106, 114 is used. For example, in the embodiments that the focus adjusting component 106, 114 includes the focusing ring or the adjusting wheel, the focus indicating number can include a degree of angle representing an angle difference between a current turning position of the focusing ring or the adjusting wheel and a target turning position of the focusing ring or the adjusting wheel (a turning position at which the current focusing value equals the peak value). The positivity and negativity of the focus indicating number indicate whether the focusing ring or the adjusting wheel needs to be turned in the counter-clockwise direction or in the clockwise direction. For example, a positive focus indicating number indicates that the focusing ring or the adjusting wheel has been turned too much in the clockwise direction and needs to be turned in the counter-clockwise direction to focus on the target object. Similarly, a negative focus indicating number indicates that the focusing ring or the adjusting wheel has been turned too much in the counter-clockwise direction and needs to be turned in the clockwise direction to focus on the target object. The absolute value of the focus indicating number indicates how many degrees the focusing ring or the adjusting wheel needs to be turned to focus on the target object.

The exemplary visual focusing prompts described above are merely examples of the focusing prompt consistent with the disclosure. As noted above, the focusing prompt can also take other forms, such as the acoustic form or the mechanical form, as described in more detail below.

In some embodiments, the acoustic focusing prompt can include a sound generated by a sound generator. In some embodiments, the sound generator can be a component of the photographing apparatus 100 or a component of the remote controller 110. In some other embodiments, the sound generator can be a stand-alone device coupled to the photographing apparatus 100 or the remote controller 110, and can be controlled by the photographing apparatus 100 (e.g., through the processor 108-4 of the photographing apparatus 100) or the remote controller 110 (e.g., through the processor 116-4 of the remote controller 110) to generate a sound.

Different sounds can be generated depending on the relative relationship between the peak value and the current focusing value. In some embodiments, the sound generated by the sound generator can correspond to the focusing value difference. For example, a first sound can be generated if the current focusing value is smaller than the peak value, a second sound can be generated if the current focusing value is larger than the peak value, and a third sound or no sound can be generated if the current focusing value equals the peak value. The first, second, and third sounds can include, e.g., beeping sounds. In some embodiments, the smaller is the focusing value difference between the current focusing value and the peak value, the louder the beeping sounds can be, or the higher repeating frequency or higher pitch the beeping sounds can have.

In some embodiments, the first, second, and third sounds can include sounds of the focus indicating numbers described above. That is, if the current focusing value is smaller than the peak value, the sound generator is triggered to generate a sound of a negative number; if the current focusing value is larger than the peak value, the sound generator is triggered to generate a sound of a positive number; and if the current focusing value equals the peak value, the sound generator is triggered to generate a sound of the number 0. The absolute value of the negative number of the positive number can represent the focusing value difference.

As described above, in the embodiments that the focus adjusting component 106, 114 includes the focusing ring or the adjusting wheel, the focus indicating number can include a degree of angle representing an angle difference between the current turning position of the focusing ring or the adjusting wheel and the target turning position of the focusing ring or the adjusting wheel. The sound generator can be triggered to generate a sound of the degree of angle.

The mechanical focusing prompt can include a vibration generated by a vibration generator. Similar to the sound generator, the vibration generator can be a component of the photographing apparatus 100 or a component of the remote controller 110, or a stand-alone device coupled to and controlled by the photographing apparatus 100 or the remote controller 110.

In some embodiments, if the current focusing value is different from the peak value, the vibration generator can be triggered to generate a vibration. If the current focusing value equals the peak value, the vibration generator may not be triggered to generate a vibration, i.e., no vibration is generated. In some embodiments, a frequency or an amplitude of the vibration can be correlated to the focusing value difference. For example, the smaller is the focusing value difference, the higher the frequency of the vibration can be or the larger the amplitude of the vibration can be.

The processes shown in the figures associated with the method embodiments can be executed or performed in any suitable order or sequence, which is not limited to the order and sequence shown in the figures and described above. For example, two consecutive processes may be executed substantially simultaneously where appropriate or in parallel to reduce latency and processing times, or be executed in an order reversed to that shown in the figures, depending on the functionality involved.

Further, the components in the figures associated with the device embodiments can be coupled in a manner different from that shown in the figures as needed. Some components may be omitted and additional components may be added.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A manual focusing assist method comprising:
analyzing an image containing an object to obtain a focusing evaluation function associated with the object, the image being captured by a photographing apparatus;
calculating a peak value for the object according to the focusing evaluation function;
obtaining a current focusing value; and
providing a focusing prompt based on the peak value and the current focusing value.

2. The method of claim 1, wherein providing the focusing prompt includes:
displaying a peak indicator representing the peak value on a display component; and
displaying a current-focus indicator representing the current focusing value on the display component,
wherein an indicator distance between the peak indicator and the current-focus indicator on the display component correlates to a focusing value difference between the peak value and the current focusing value.

3. The method of claim 2, wherein:
displaying the peak indicator includes displaying the peak indicator at a selected location on the display component, and
displaying the current-focus indicator includes:
if the current focusing value is smaller than the peak value, displaying the current-focus indicator to a first side of the selected location,
if the current focusing value is larger than the peak value, displaying the current-focus indicator to a second side of the selected location, the second side being opposite to the first side, and
if the current focusing value equals the peak value, displaying the current focus indicator at the selected location.

4. The method of claim 3, wherein the selected location corresponds to a location of an object image of the object on the display component.

5. The method of claim 2, wherein:
displaying the peak indicator includes displaying the peak indicator at a middle point of a scale displayed on the display component, and
displaying the current-focus indicator includes:
if the current focusing value is smaller than the peak value, displaying the current-focus indicator at a first portion of the scale that is on a first side of the middle point,
if the current focusing value is larger than the peak value, displaying the current-focus indicator at a second portion of the scale that is on a second side of the middle point, the second side being opposite to the first side, and
if the current focusing value equals the peak value, displaying the current focus indicator at the middle point.

6. The method of claim 5, wherein the scale includes a semi-circle.

7. The method of claim 2, wherein:
displaying the peak indicator includes displaying a first frame, and
displaying the current-focus indicator includes displaying a second frame concentric with the first frame.

8. The method of claim 7, wherein displaying the second frame includes:
if the current focusing value is smaller than the peak value, displaying the second frame inside the first frame,
if the current focusing value is larger than the peak value, displaying the second frame to enclose the first frame, and
if the current focusing value equals the peak value, displaying the second frame to overlap the first frame.

9. The method of claim 7, wherein displaying the second frame includes:
if the current focusing value is smaller than the peak value, displaying the second frame to encircle the first frame,
if the current focusing value is larger than the peak value, displaying the second frame inside the first frame, and
if the current focusing value equals the peak value, displaying the second frame to overlap the first frame.

10. The method of claim 7, wherein:
displaying the first frame includes displaying a first ring, and
displaying the second frame includes displaying a second ring concentric with the first ring.

11. A manual focusing assist device comprising:
a processor; and
a memory storing instructions that, when executed by the processor, cause the processor to:
analyze an image containing an object to obtain a focusing evaluation function associated with the object, the image being captured by a photographing apparatus;
calculate a peak value for the object according to the focusing evaluation function;
obtain a current focusing value; and
provide a focusing prompt based on the peak value and the current focusing value.

12. The device of claim 11, wherein the instructions further cause the processor to:
display a peak indicator representing the peak value on a display component; and
display a current-focus indicator representing the current focusing value on the display component,
wherein an indicator distance between the peak indicator and the current-focus indicator on the display component correlates to a focusing value difference between the peak value and the current focusing value.

13. The device of claim 12, wherein the instructions further cause the processor to:
display the peak indicator includes displaying the peak indicator at a middle point of a scale displayed on the display component, and display the current-focus indicator:
at a first portion of the scale that is on a first side of the middle point if the current focusing value is smaller than the peak value,
at a second portion of the scale that is on a second side of the middle point if the current focusing value is larger than the peak value, the second side being opposite to the first side, and
at the middle point if the current focusing value equals the peak value.

14. The device of claim 13, wherein the scale includes a semi-circle.

15. The device of claim 12, wherein the instructions further cause the processor to:
display a first frame as the peak indicator, and
display a second frame as the current-focus indicator, a center of the second frame overlapping a center of the first frame.

16. The device of claim 15, wherein the instructions further cause the processor to:
if the current focusing value is smaller than the peak value, display the second frame inside the first frame,
if the current focusing value is larger than the peak value, display the second frame to encircle the first frame, and
if the current focusing value equals the peak value, display the second frame to overlap the first frame.

17. The device of claim 15, wherein the instructions further cause the processor to:
if the current focusing value is smaller than the peak value, display the second frame to encircle the first frame,
if the current focusing value is larger than the peak value, display the second frame inside the first frame, and
if the current focusing value equals the peak value, display the second frame to overlap the first frame.

18. The device of claim 15, wherein the instructions further cause the processor to:
display a first ring as the first frame, and
display a second ring as the second frame, the second ring being concentric with the first ring.

19. The device of claim 18, wherein the instructions further cause the processor to:
if the current focusing value is smaller than the peak value, display the second ring inside the first ring,
if the current focusing value is larger than the peak value, display the second ring to encircle the first ring, and
if the current focusing value equals the peak value, display the second ring to overlap the first ring.

20. The device of claim 18, wherein the instructions further cause the processor to:
if the current focusing value is smaller than the peak value, display the second ring to encircle the first ring,
if the current focusing value is larger than the peak value, display the second ring inside the first ring, and
if the current focusing value equals the peak value, display the second ring to overlap the first ring.
